(19) United States
(12) Patent Application Publication
(10) Pub. No.: US 2017/0109761 A1
(43) Pub. Date: Apr. 20, 2017

(54) GLOBAL NETWORKING SYSTEM FOR REAL-TIME GENERATION OF A GLOBAL BUSINESS RANKING BASED UPON GLOBALLY RETRIEVED DATA

(71) Applicant: THE DUN & BRADSTREET CORPORATION, Short Hills, NJ (US)

(72) Inventors: Alla KRAMSKAIA, Edison, NJ (US); Nipa BASU, Warren, NJ (US); Jingtao Jonathan YAN, Princeton, NJ (US); Karolina KIERZKOWSKI, Linden, NJ (US); Nalanda MATIA, Chatham, NJ (US); Joseph ANDREACCHI, Morristown, NJ (US); Peter F. KINKEL, Lebanon, NJ (US)

(21) Appl. No.: 15/291,385

(22) Filed: Oct. 12, 2016

Related U.S. Application Data
(60) Provisional application No. 62/242,075, filed on Oct. 15, 2015.

(51) Int. Cl. G06Q 30/02; G06Q 10/06

(52) U.S. Cl. CPC G06Q 30/0201; G06Q 10/067

(57) ABSTRACT

A networking system for real-time generation of a global business ranking based upon country specific data retrieved from at least a plurality of countries, the system comprising: a plurality of country data collection systems, wherein the country specific data is collected from a plurality of country sources; a transformation engine which receives and categorizes the collected data into at least one selected from the group consisting of: country trade data, country financial data and country derogatory information; a data/attribute repository which merges the country trade data, country financial data and/or country derogatory information with data from a global database, macro score data and/or signal score data to form merged data, and sorts the merged data into at least one selected from the group consisting of: global trade data, global financials data and global derogatory information; and a global business ranking processor which retrieves any of the global trade data, global financials data and/or global derogatory information on a real-time basis and generates the global business ranking for a particular business entity.

### CROSS-REFERENCED APPLICATIONS

This application claims priority to U.S. Provisional Application No. 62/242,075, filed on Oct. 15, 2015, which is incorporated by reference herein in its entirety.

### BACKGROUND

1. Field of the Disclosure

This disclosure relates generally to a global networking system for real-time gathering of data from differing time zones and to enable the generation of a global business ranking (GBR) of any business entity worldwide in terms of business information transparency and availability even if all of the data is not currently available due to time zone differences. In particular, the system enables real-time generation of a GBR based upon globally retrieved information, such as data, from multiple sources and/or countries throughout the world.

2. Discussion of the Background Art

It is known to produce a business ranking for a business in a given country. Generally, these business rankings do not address a business ranking on a global scale. Moreover, a ranking score does not include components based on data from a group of global countries in different time zones, for example 100 or more. Due to differing time zones and the inherent lag in transferring of data from various countries throughout the world, there is often a problem of producing a GBR when data from different countries is incomplete or lagging due to such time zone differences. Therefore, a party in, for example, Japan seeking a GBR on a multinational company which operates in, for example, the United States, Argentina and Israel may not have real-time access to the data necessary in generating an accurate real-time and up-to-date GBR. The technical problem resides in the fact that users are seeking real-time access to GBR scores based upon data collected throughout the world which is retrieved and stored at different locations, different time zones and in different formats, etc., thereby causing substantial time delays in generating GBR scores until all of the data is collected and synced. In today's global world and need for real-time and instant access to information, it is no longer feasible or acceptable to expect users to wait hours or days for requested information.

This disclosure provides a system and method to generate in real-time a global business ranking based on activities in a group of global countries, regardless of whether or not the data is complete.

### SUMMARY

A networking system for real-time generation of a global business ranking based upon country specific data retrieved from at least a plurality of countries, the system comprising: a plurality of country data collection systems, wherein the country specific data is collected from a plurality of country sources; a transformation engine which receives and categorizes the collected data into at least one selected from the group consisting of: country trade data, country financial data and country derogatory information; a data/attribute repository which merges the country trade data, country financial data and/or country derogatory information with data from a global database, macro score data and/or signal score data to form merged data, and sorts the merged data into at least one selected from the group consisting of: global trade data, global financials data and global derogatory information; and a global business ranking processor which retrieves any of the global trade data, global financials data and/or global derogatory information on a real-time basis and generates the global business ranking for a particular business entity.

The global business ranking processor comprises a blended module which produces the global business ranking even if any or all of the global trade data, global financials data and/or global derogatory information is incomplete by using a statistical model or business knowledge to fill in any deficient information or data.

Preferably, the global business ranking is stored in a global business ranking repository.

The transformation engine further processes the collected data by translating, standardizing and/or summarizing the collected data pursuant to country specific logic and/or rules.

The country data collection system comprises parallel processing of the country specific data from the plurality of country sources.

The global business ranking repository pushes global business rankings for the business entity downstream and/or continuously feeds the global business rankings for the business entity to a user in real-time without the need for awaiting the downloading and/or processing of all the country specific data.

The global business ranking which has been provided to the user is fed back to the global business ranking processor via neural net or other artificial intelligence technology to improve the global business ranking generated via the global business ranking processor.

### BRIEF DESCRIPTION OF THE DRAWINGS

Other and further objects, advantages and features of the present disclosure will be understood by reference to the following specification in conjunction with the accompanying drawings, in which like reference characters denote like elements of structure and:

FIG. 1 is a block diagram of a GBR system according to the present disclosure;

FIG. 2 is a block diagram of a macro score hardware of the GBR system of FIG. 1;

FIG. 3 is a block diagram of a signal score hardware of the GBR system of FIG. 1;

FIG. 4 is a block diagram of a global trade hardware of the GBR system of FIG. 1;

FIG. 5 is a block diagram of a global financial hardware of the GBR system of FIG. 1;

FIG. 6 is a block diagram of a global derogatory information hardware of the GBR system of FIG. 1;

FIG. 7 is a block diagram of the GBR master processing and scoring system of FIG. 1;

FIG. 8 is a logic diagram for GBR Master Scoring Module in FIG. 7;

FIG. 9 is a processing diagram for a pre macro modeling phase used by the macro score hardware of FIG. 4;

FIGS. 10 and 11 combined exemplify a processing diagram for a macro modeling phase used by the macro score hardware of FIG. 4; and

FIG. 12 is a block diagram of the global GBR system according to the present disclosure.

### DETAILED DESCRIPTION OF THE PREFERRED EMBODIMENT

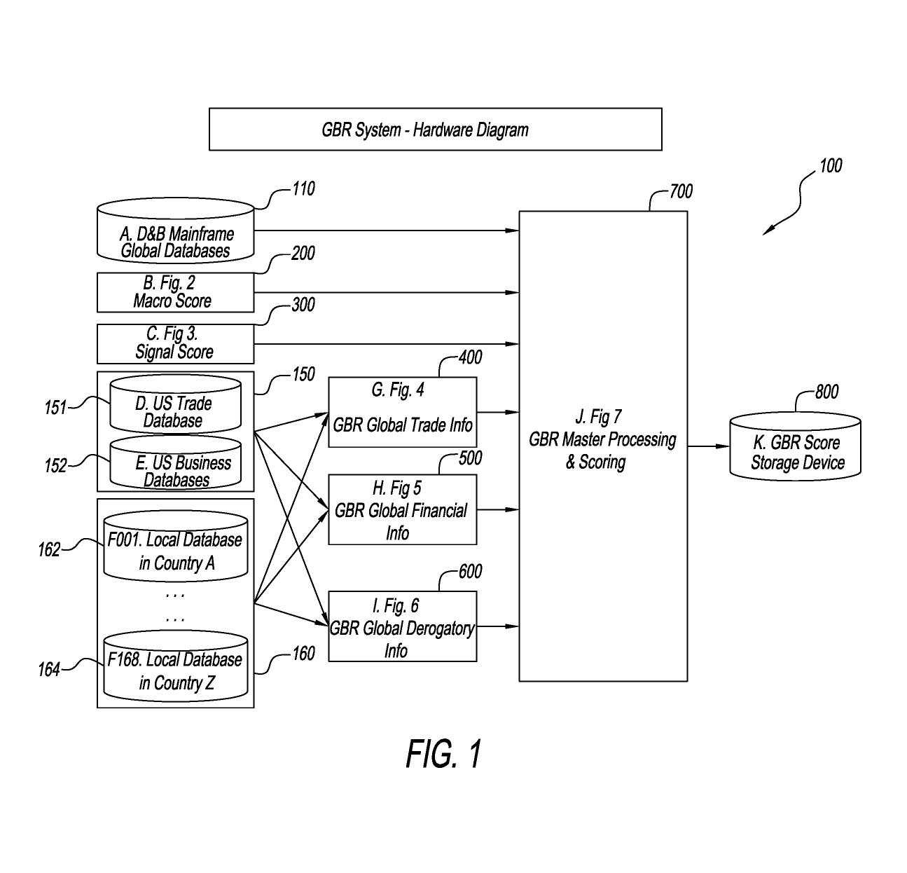

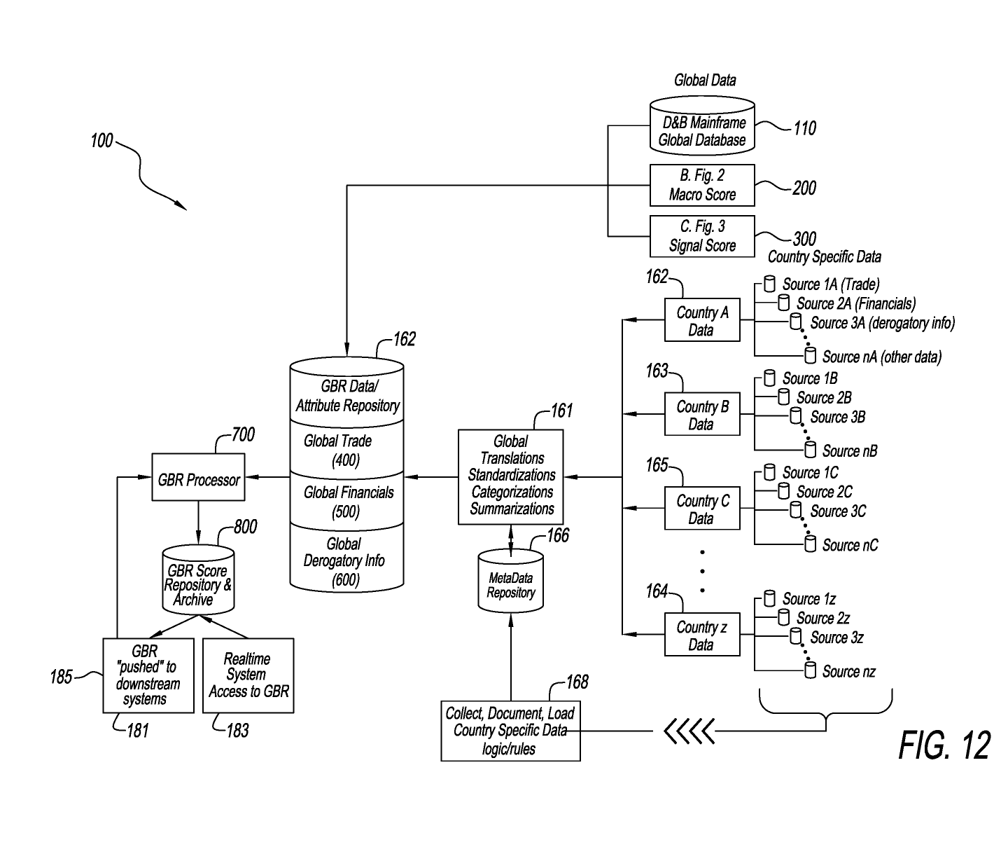

Referring to FIGS. 1 and 12, a GBR system 100 of the present disclosure comprises a GBR master hardware system 700, which receives inputs from a plurality of sources, namely, a mainframe global database 110, a macro score hardware 200, a signal score hardware 300, a GBR global trade hardware 400, a global financial hardware 500 and a global derogatory hardware 600. GBR master hardware system 700 processes the received inputs to provide a GBR ranking score to a GBR score storage device 800.

GBR global trade hardware 400, global financial hardware 500 and global derogatory hardware 600 each receive inputs from trade database groups 150 and 160. Trade database group 150 comprises one or more trade databases from one or more trade databases of a local country, such as the United States (US). Trade database group 160 comprises one or more trade databases in a global collection of countries, such as a local data base 162 in the United Kingdom (UK), a local database 164 in Brazil and many other countries throughout the world.

The present disclosure provides a technical solution that allows for the unique collection of global data and real-time processing and generation of GBR scores based upon the globally collected data. This technical solution is best understood by reference to FIG. 12.

FIG. 12 depicts a block diagram of GBR system 100 comprising the collection of various country specific data, e.g., country A data 162, country B data 163, country C data 165 and country Z data 164. For each country A through Z data is collected from various sources, e.g., country A data 162 uploads data in parallel from at least source 1A (trade), source 2A (financial), source 3A (derogatory information), through source nA (other data). Similar, country B data, country C data through country Z data retrieves its' respective source data in parallel from its respective sources. Thereafter, the respective country data from 162, 163, 165 through 164 are processed in parallel such that as data is acquired from their respective sources it is sent to transformation engine 161 where the data is translated, standardized, categorized and/or summarized pursuant to the rules and formatting stored in meta data repository 166. The country specific logic/rules are established in step 168 and stored in meta data repository 166.

Thereafter, once transformation engine 161 has processed the individual country data received from 162, 163, 165 through 164 it is sent to a GBR data/attribute repository 169 where it is merged with data from global database 110, macro score 200 and signal score 300. Data/attribute repository 169 sorts the merged data into global trade data 400, global financials data 500 and global derogatory information 600. By pre-sorting the data in repository 169, the GBR processor 700 can retrieve any of such trade 400, financials 500 or derogatory information 600 on a real-time basis, provided that at least one of global trade data 400, global financials data 500 and global derogatory information 600 has complete information, thereby avoiding the need to wait for each of the other data/attribute repository data from being complete and up-to-date. This is especially useful when you are relying on data from multiple sources and countries to be processed via transformation engine 161 and apportioned in separate and distinct data/attribute repositories, e.g., global trade data 400, global financials data 500 and global derogatory information 600. GBR processor 700 uses a blended module to take incomplete data from global trade data 400, global financials data 500 and global derogatory information 600 (i.e. business knowledge) on a continuous feed basis to meet the on demand requirements of users, thereby using statistics to fill in the deficient information and still produce an accurate GBR score which is stored in repository 800.

By creating a blended module, parallel processing, and continuous feed basis system, the present disclosure enables GBR system 100 to either push GBR scores downstream 181or retrieve data requested by a user 183 in real-time without the need for awaiting the downloading and processing of all data from each country A-Z and their respective data sources. In addition, it is possible to use neural net or other artificial intelligence technology to continuously improve the GBR scores generated by GBR processor 700 via the recursive feedback loop 185 of information pushed to downstream system 181.

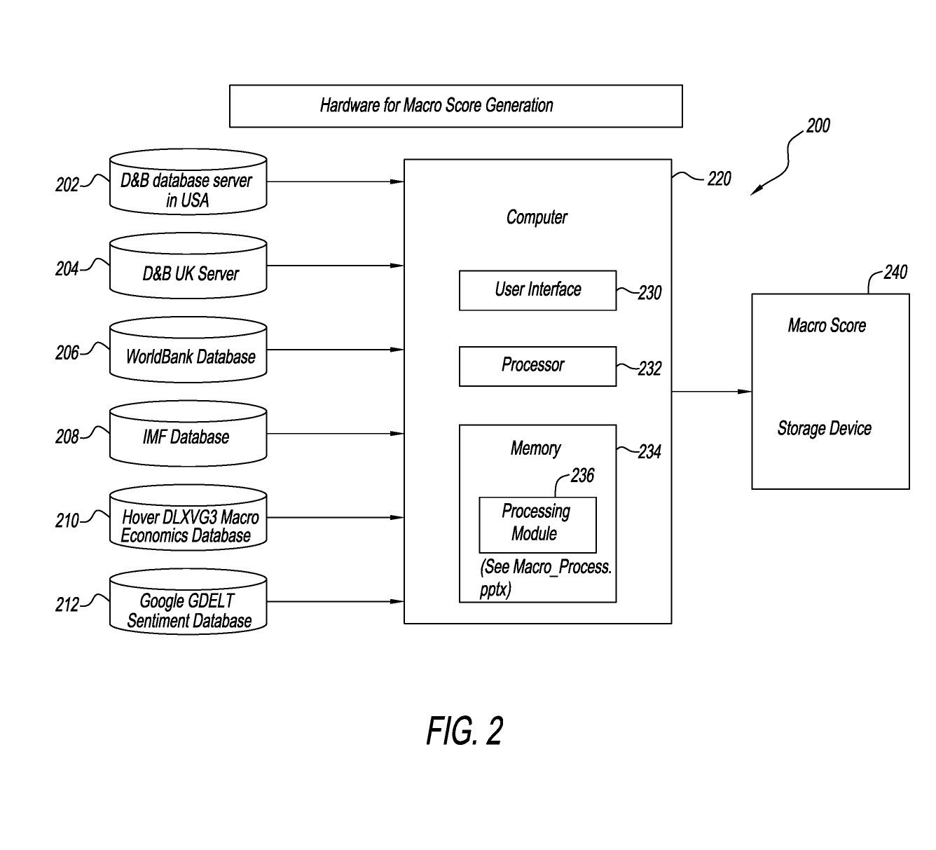

Referring to FIG. 2, macro score hardware 200 comprises a computer 220 that has a user interface 230, a processor 232 and a memory 234. A processing module 236 is stored in memory 234. Computer 220 receives inputs from a USA data base server 202, a UK server 204, a World Bank database 206, an IMF (International Monetary Fund) database 208, a macroeconomics database 210 and a Google GDELT (Global Database of Events, Language, and Tone) sentiment database 212. Processor 220 operates processing module 236 to process these inputs and provide a macro score stored in 240.

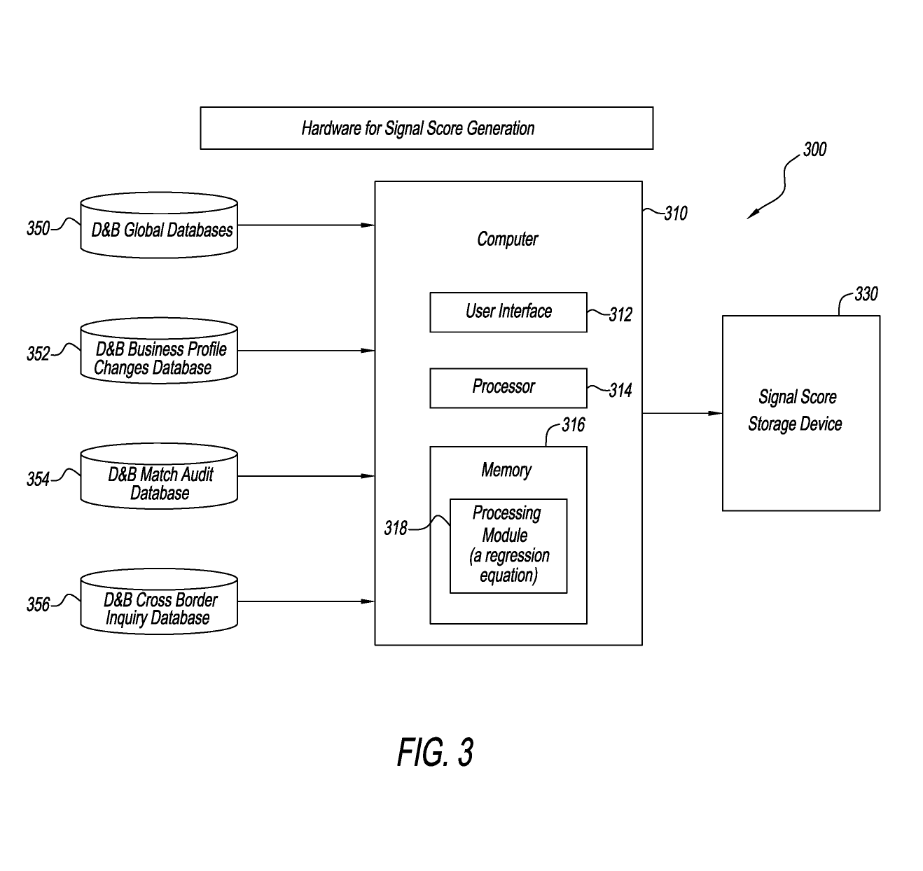

Referring to FIG. 3, signal score hardware 300 comprises a computer 310, a global database(s) 350, business profile changes database 352, a match audit database 354, and a cross border inquiry database 356. Computer 310 comprises a user interface 312, a processor 314 and a memory 316. Memory 316 comprises a processing module 318 that processes obtained information from global database(s) 350, business profile changes database 352, match audit database 354, and cross border inquiry database 356 for processing to produce a signal score stored in 330.

By coupling global database 350 and business profile changes database 352, (e.g., change of CEO), as well as frequency of changes for a given business are obtained. Global database 350 provides information, such as change of CEO, and business profile changes database 352 provides information, such as frequency of changes, for a given business. Match audit database 354 contains information (e.g., such as number of matches and audits on that business, as well as length of time signal activities cover) indicating how active the signal data, i.e. active in terms of how recent and how frequent of a business activity, and signal data generally relates to business inquiries (e.g., negative media coverage, change of CEO, etc.) for a particular business. The higher number of matches and audits and/or the longer period of time with signals indicate a more active or more prosperous business. Cross border inquiry database 356 has cross border inquires on that business. Inquiries from higher number of different countries and inquiries over longer period of time are indicators for better business.

Processing module 318 pools all the above signal data items, i.e. putting together data signals, e.g., business inquiries, negative media coverage, and change of CEO. A regression model applies different weights to them, and sums the weighted values into a single signal score. This signal score shows the risk level of a business, solely based on signal information available.

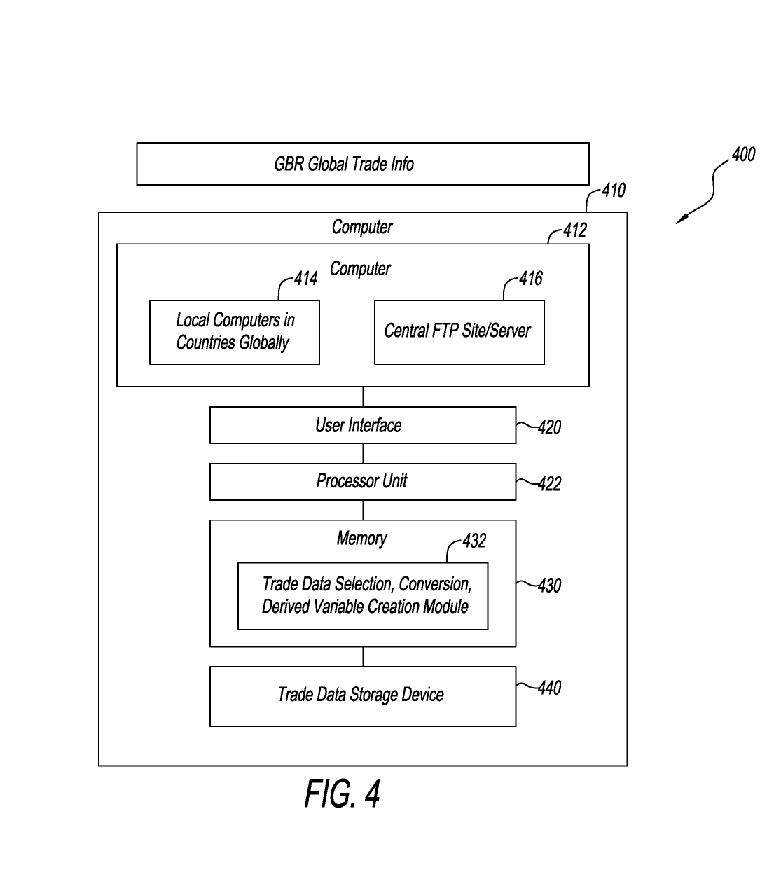

Referring to FIG. 4, GBR global trade hardware 400 comprises a computer 410 that comprises a user interface 420, a processor unit 422, a memory 430 and a trade storage device 440. A computer system 412 comprises local computers 414 in global countries and a central FTP (file transfer protocol) server 416 that provide an input to user interface 420. Local computers 414 use trade data bases 150 and 160 in their respective countries to provide inputs to computer 410.

Memory 430 comprises a processing module 432 for trade data selection, conversion and derived variable creation. The result of processing module 432 is then stored in financial storage device 440.

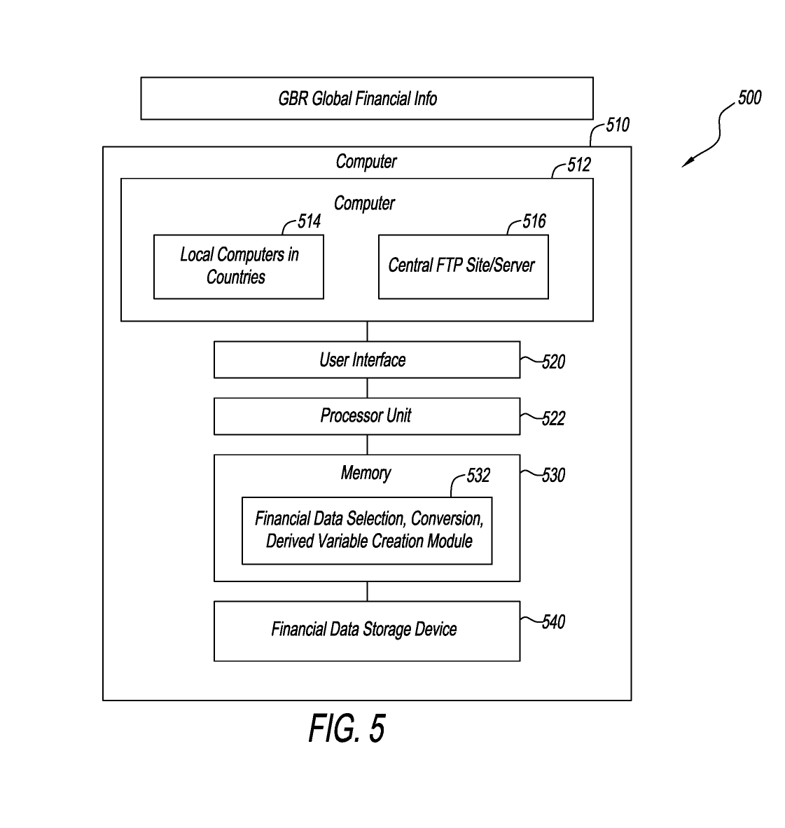

Referring to FIG. 5, GBR global financial hardware 500 comprises a computer 510 that comprises a user interface 520, a processor unit 522, a memory 530 and a trade storage device 540. A computer system 512 comprises local computers 514 in global countries and a central FTP server 516 that provide an input to user interface 520. Local computers 514 use trade databases 150 and 160 in their respective countries to provide inputs to computer 510.

Memory 530 comprises a processing module 532 for trade data selection, conversion and derived variable module. The result of processing module 532 is then stored in financial storage device 540.

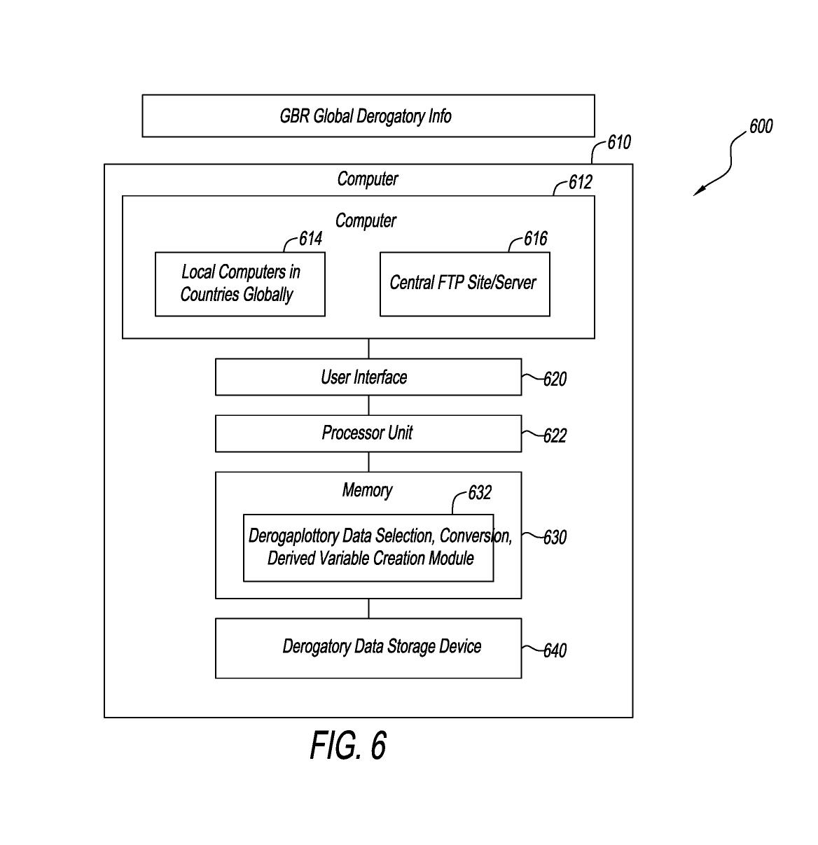

Referring to FIG. 6, GBR global derogatory hardware 600 comprises a computer 610 that comprises a user interface 620, a processor unit 622, a memory 530 and a derogatory data storage device 640. A computer system 612 comprises local computers 614 in global countries and a central FTP server 616 that provide an input to user interface 620. Local computers 614 use trade databases 150 and 160 in their respective countries to provide inputs to computer 610.

Memory 630 comprises a processing module 632 for trade data selection, conversion and derived variable creation. The result of processing module 632 is then stored in derogatory data storage device 640.

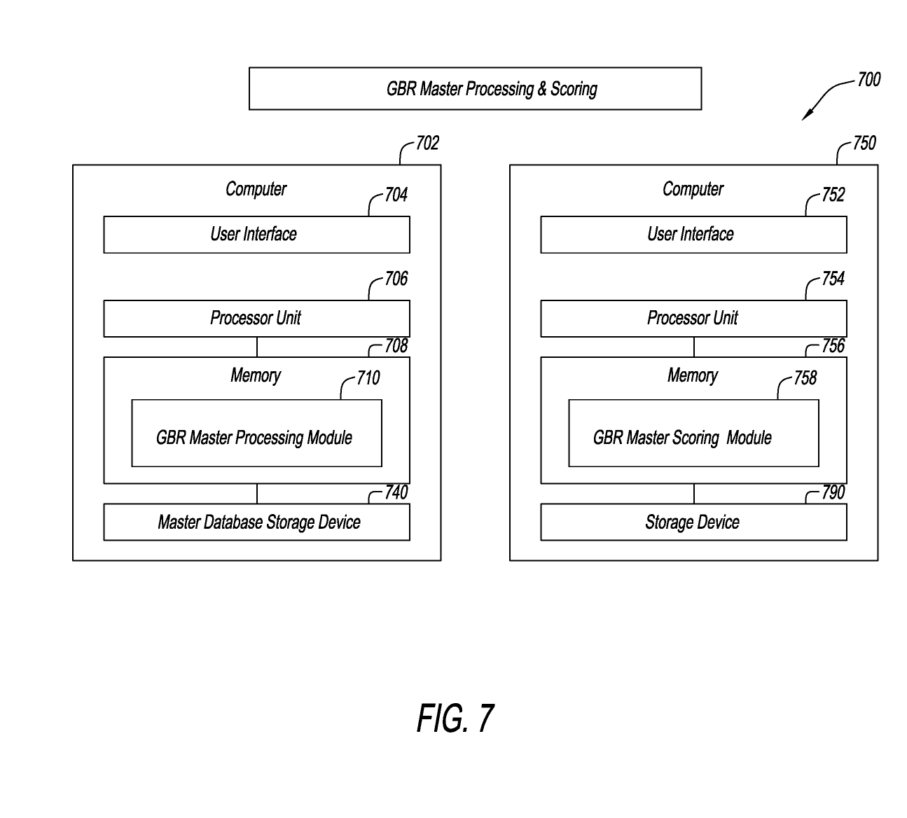

Referring to FIG. 7, GBR master processing and scoring hardware system 700 comprises a computer 702 and a computer 750. Also referring to FIG. 1, computer 702 receives inputs from main frame global databases 110, macro score hardware 200, signal score hardware 300, GBR global trade information 400, GBR global financial information 500 and GBR global derogatory information 600. Computer 702 comprises a user interface 704, a processor unit 706, a memory 708 and a master database storage device 740. Computer 702 and additional computer 750 enable the system to simultaneously undertake two sequential steps. GRB master processing module 710 in computer 702 puts together all macro, signal, trade, financial, and derogatory data (FIGS. 2 thru 6). GBR master scoring module 758 in additional computer 750 applies GBR models to the final big data file retrieved from master database storage device 740 to generate and store GBR scores in storage device 790.

A GBR master processing module 710 is disposed within memory 708. Processor unit 706 uses GBR master processing module 710 to process the inputs from main frame global databases 110, macro score hardware 200, signal score hardware 300, GBR global trade information 400, GBR global financial information 500 and GBR global derogatory information 600 to pull all input files together and generate the master dataset to be used for 750. Processor unit 706 then stores this result in the master database storage device 740.

Computer 750 comprises a user interface 752, a processor unit 754, a memory 756 and a storage device 790. Processor unit 754 uses the input from computer 702 to generate the final GBR score for storage in storage device 790 and for storage in GBR score storage device 800 (FIG. 1).

With respect to FIG. 2, processing module 236, which when executed by processor 232, performs a pre-modeling phase and a modeling phase. The pre-modeling phase creates a macro adjustment factor that ensures the ranking of countries by the bad definition makes sense from the economic perspective. The data preparation steps (1005 through 1050) in modeling phase comprises two separate paths corresponding to data-abundant vs. data-not-abundant countries. 1055 uses data for those two types countries and generates macro scores for all countries.

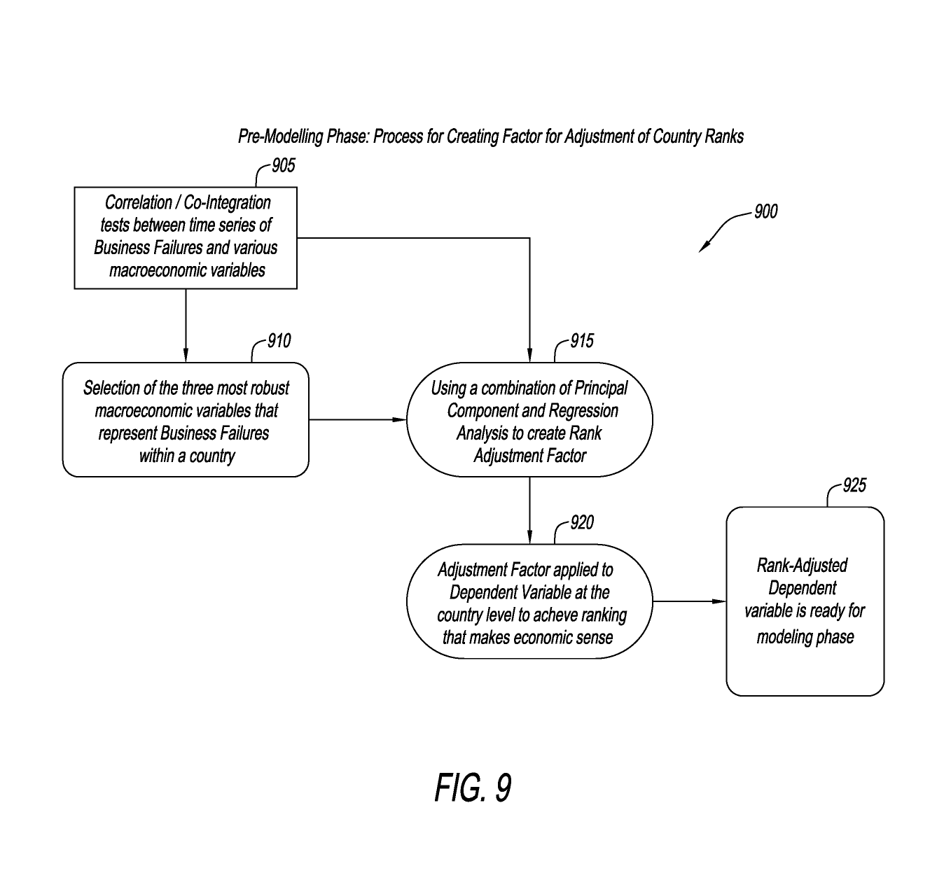

Referring to FIG. 9, processing module 236 when run by processor 232 for the pre-modeling phase performs a plurality of steps to achieve a rank-adjusted dependent variable. At step 905, correlation/co-integration tests are performed between time series of business failures and various macroeconomic variables. At step 910, a selection is made of the three most robust macroeconomic variables that represent business failures within a country. At step 915, a combination of principal component and regression analysis is used to create a rank adjustment factor. At step 920, the rank adjustment factor is applied to a dependent variable at the country level to achieve ranking that makes economic sense. At step 925, the rank-adjusted variable is ready for the modeling phase.

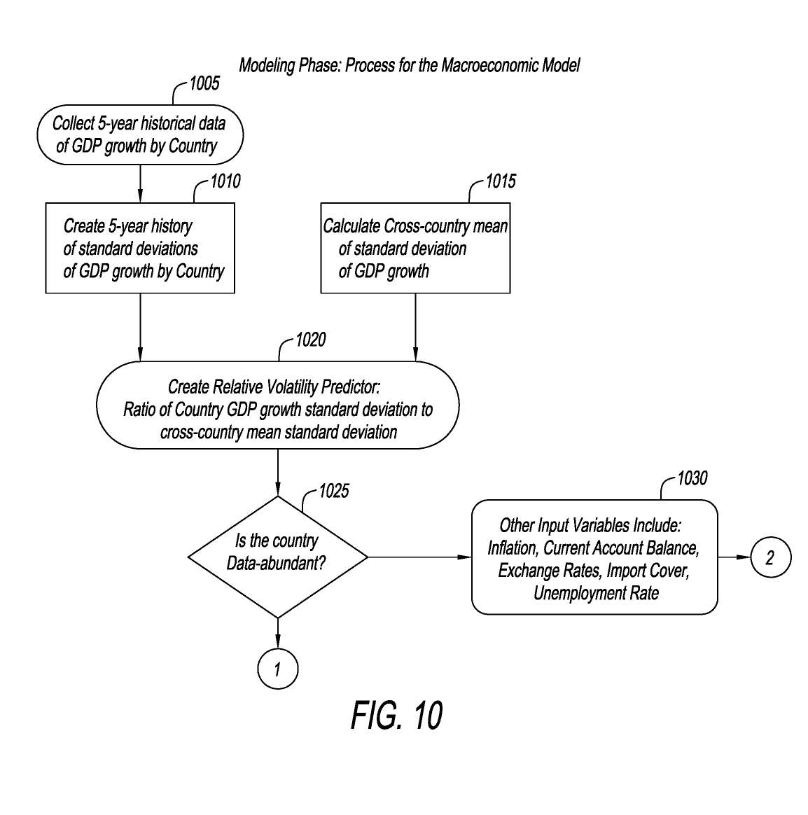

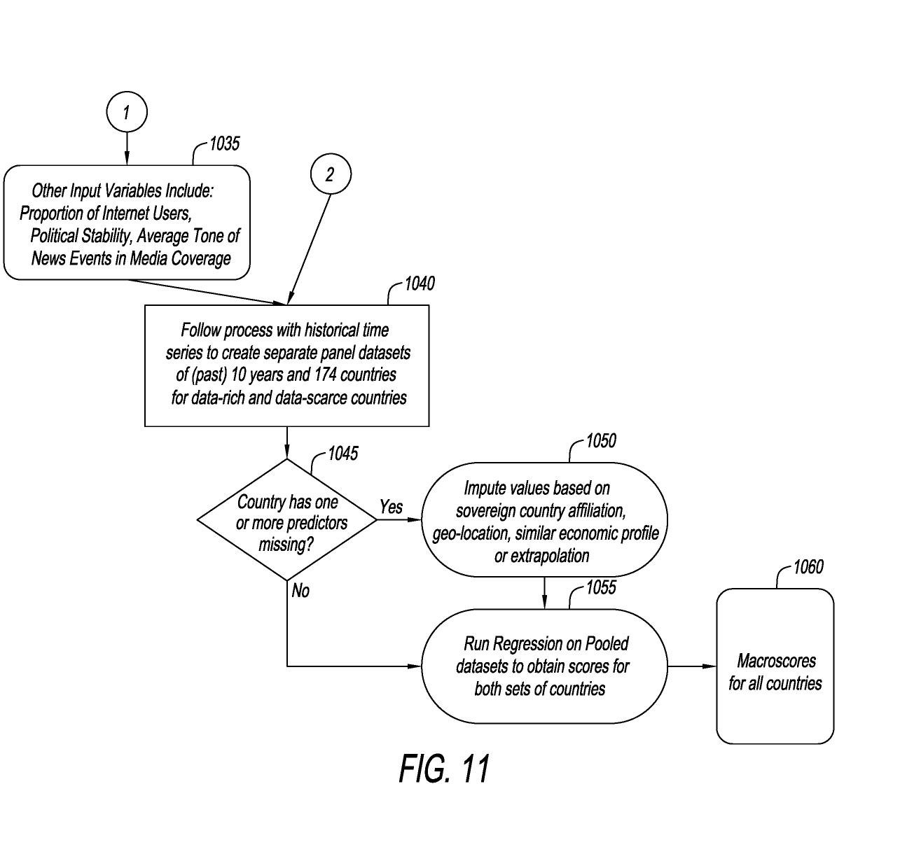

Referring to FIGS. 10 and 11, processing module 236 when run by processor 232 for the modeling phase performs a plurality of steps to achieve a macro score component for incorporation into a GBR score. Referring first to FIG. 10, at step 1005, collects a 5-year historical data of GDP growth by country. At step 1010, a 5-year history of standard deviations of GDP of GDP growth by country is created. At step 1015, a cross-country mean of standard deviation of GDP growth is determined. At step 1020, relative volatility predictor is created based on a ratio of country GDP growth standard deviation to cross-country mean standard deviation. At step 1025, a determination is made of whether the country data is abundant. If yes, at step 1030, other input variables are considered. The other input variables without limitation includes one or more of inflation, current account, balance, exchange rates, import cover, unemployment rate.

Referring also to FIG. 11, if no at step 1025, at step 1035, a different set of input variables is also considered. This set of input variables without limitation includes one or more of proportion of internet users, political stability, and average tone of news events in media coverage.

For each variable included in 1030 and 1035, its past 10-year historic time series panel data is extracted (1040). For each of 1030 and 1035, there is a corresponding output dataset.

1045 checks the two output datasets, and flags those countries that have one or more predictors missing.

If a country is flagged, then its missing data will be replaced with values imputed based on sovereign country affiliation, geo-location, similar economic profile or extrapolation (1050).

Data-rich and data-scarce countries, which when combined covers all countries.

The macro score for any given country is a numerical number from 1 to 100, e.g., a country with a macro score of 95 is low in risk in terms of business environments and business entities, whereas a country with a macro score of 20 would indicate a county high in overall business risk.

Referring to FIGS. 1 and 7, processor unit 706 operates GBR master processing module 710 to obtain data inputs from mainframe global database 110, macro score hardware 200, signal score hardware 300, GBR global trade hardware 400, global financial hardware 500 and a global derogatory hardware 600 for storage in master database storage device 740.

For an example of a multinational portfolio of clients (companies) from the United Kingdom (UK), these inputs include:
1) clients' information on mainframe global databases 110 (FIG. 1),
2) UK's macroeconomic score created and extracted (FIG. 2),
3) signal score (CEO change, inquiries, etc.) from signal score hardware 300,
4-6) Local databases in UK FIG. 1 (F001) are searched for financial information, trade information, and derogatory information.
   These 6 groups of information are fetched by operation of GBR master processing module and stored in GBR database storage device 740.

Referring to FIG. 7, processor unit 754 operates GBR master scoring module 758 to use one or more of the above noted 6 inputs to produce GBR scores for storage in GBR storage device 790.

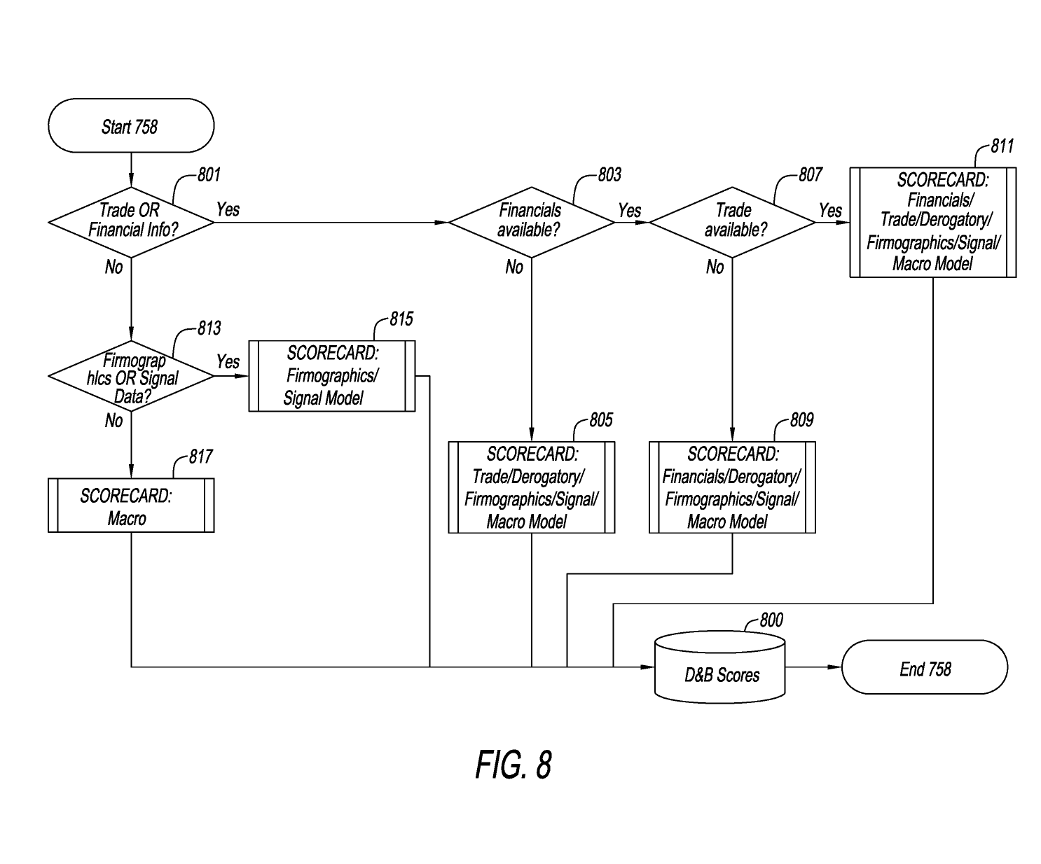

FIG. 8 provides a logic diagram pertaining to the GBR score generation according to the present application.

Below is an example illustrating the process for generating a global business ranking (GBR) for a particular entity, wherein the GBR score remains consistent regardless of the country of domicile of the particular entity of interest.

For example, a US-based company has a multi-national portfolio of its suppliers. One of its suppliers is a UK-based company named ABC. Before doing business with ABC, the US-based company seeks to determine the GBR score for ABC, which is calculated via the following steps.

Retrieve ABC's firmographic data, such as age (40 years), number of employees (200 employees), Standard Industry Code, etc. from a global database 110.

Create and retrieve a country specific macro score value through 200. UK information needed to generate UK macro score are extracted as follows:
Country Bad Rate, Annual Average Inflation, and Import Cover Ratio from 202, Political Stability Index from 204, Unemployment Rate and Internet Usage from 206, GDP Growth and Current Account As Percentage of GDP from coupling of data from servers 202 through 212, average tone of media events from Google GDELT sentiment database 212.
Processing module 236 in FIG. 2 works as follows. Pull GDP Growth for all countries, including UK, from databases 202 through 212. Based on GDP Growth by country, generate standard deviation of GDP Growth, and mean of GDP Growth standard deviation cross countries. Standard deviation of GDP Growth is a volatility measurement in statistics. Relative Volatility Predictor for UK is the ratio of UK GDP Growth standard deviation over the GDP Growth standard deviation cross all countries. Relative Volatility Predictor shows a country's business risk level relative to global average. A country's Relative Volatility Predictor greater than 1 indicates business risk in that country is higher than global average.
Generate the UK macro score, based on a regression equation that assigns weights for above-mentioned data items, including Relative Volatility Predictor, and sums weight values into the macro score.

Macro score storage device 240 stores this UK macro score.

Compared with other countries, such as Brazil with a macro score of 1250, UK is less risky in business as a country overall, and thus has a better macro score of 1285. This can be explained from the information items as above-specified that go into the calculation of UK macro score.

This difference in UK versus Brazil macro scores helps make it possible to compare GBR scores between UK and Brazil, apples to apples. The final GBR score has the following six components:

1. Financial

2. Trade

3. Derogatory

4. Signal Score

5. Macro Score

6. Firmographics

If the UK company and the Brazil company are the same for data items in Components 1, 2, 3, and 4, above, they will have the same risk score, before macro score and firmographics are included.

Regarding Component 5, i.e. macro score, since the UK has better macro score than Brazil, the UK company will have a better GBR score of 1285 than the Brazil company at 1250.

Further assuming those two companies have the same firmographics, such as age, employee size, SIC, etc. GBR component 6, firmographics, have different formula to calculate risk for different countries based on firmographics. Those two companies, though with same firmographics, will have different risk scores from component 6, because of different calculation formula/models.

That is, the final GBR score takes into consideration of all the above 6 components, including macro score and firmographics score. Consequently, the two UK and Brazil companies will have two different final GBR scores, based on consistent measurement benchmarks, and the scores can be compared apples to apples.

Retrieve a signal score value 300.

For UK company ABC, after coupling global database 350 and business profile changes database 352, types of business profile changes (e.g., change of CEO) as well as frequency of changes for ABC are obtained. Match audit database 354 provides information indicating how active the signal data is for ABC, information, such as number of matches and audits on ABC, as well as length of time the signal activities cover. Higher number of matches and audits and/or longer period of time with the signals indicate ABC is more active in business and/or have more business relationships. Cross Border inquiry database 356 has cross border inquires on that business. Higher in inquiries can be either good or bad indication of business, but if there is no inquires on ABC for a relatively long period of time indicate risk for doing business with ABC.

Processing module 318 pools all the above signal data items together. A regression model applies different weights to them, and sums the weighted values into a single signal score.

Below is for illustration purposes, as other calculations can be used in GBR process. This example on signal data can also be used for all other parts of GBR, such as score by demographics, financials, and trade information, etc.

Company ABC, in the last 3 months, had 10 cross-border inquires, and those inquiries were from 7 countries. In the previous year, ABC's CEO resigned, and there were 3 negative media coverages on ABC.

First, each of the above 4 raw data values are converted into predicator values, based on a Weight of Evidence tables. The Weight of Evidence tables were created for all predictors during modeling creation process, based on a model sample. Below is one for the predictor of Number of Cross Border Inquiries.

Weight of Evidence (WOE) Table for Cross Border Inquires

| Number of Inquiries | Weight of Evidence |
|---|---|
| 1-3 | 0.10 |
| 4-6 | 0.60 |
| 7+ | 1.46 |
| Missing | −0.17 |

1. 10 (inquires) is converted to 1.46 (weight of evidence)

2. 7 (countries) is converted to 1.52 (weight of evidence)

3. Change of CEO is converted to −1.12 (weight of evidence)

4. 3 (negative media coverage) is converted to −0.74 (weight of evidence)

Applying above Weight of Evidence values to GBR Signal model:

$$\begin{matrix}Log\_odds = - 0.4207 \\ - 0.7005 * Inquires ( 1.46 ) \\ - 0.2125 * Countries ( 1.52 ) \\ - 0.3281 * ChangeOfCEO ( - 1.12 ) \\ - 0.2788 * NegativeMedia ( - 0.74 ) \\ = - 1.1926\end{matrix}$$

$$\begin{matrix}Score = 1130 - 40 / Ln ( 2 ) * Log\_odds \\ = 1061\end{matrix}$$

Company ABC has signal score of 1061.

This signal score ranges from 1001 to 1500, with 1001 as most risky and 1500 as least risk. This signal score shows the risk level of a business, solely based on signal information available.

Let's say ABC has a signal score of 1439, a relatively good score, because there are many matches and audits as well as cross border inquires that are available for ABC, and there is no business profile changes such as change of CEO, etc.

Retrieve GBR global trade information 400 from US trade database 151 and US business database 152 from trade database group 150 and country database group 160.

Trade information entails how business entities pay their debt obligations. For GBR models, which are general business risk models, we used following information items:

1. Number of trades in last 12 month

2. Payments that are promptly paid

3. Payments that are paid within 30 days past due

4. Payments 31-60 days past due

5. Payments 61-90 days past due

6. Payments 91-120 days past due

7. Payments 121-150 days past due

8. Payments 151-180 days past due

9. Payments 181+ days past due

Global partners 414 in FIG. 4 provide trade data from their local computers/servers/databases, which spread all over the world, to a centralized FTP site/server 416 through the method of File Transfer Protocol (FTP). Trade data selection, conversion, derived variable creation module 432 combines all of the local data into one final trade database, and stores the trade data in storage device 440.

Databases 150 and 160 contain, among others, the following trade information for US (i.e. US trade database 151 and US business database 152) and for other countries (i.e. local databases for individual local countries 162 thru 164). Such information for US and other countries include, but are not limited to:
number of months with reported detailed trades within the last 12 months
Paydex Score
Total Amount Owing in last 12 months
total # of payment experiences in last 12 months
number of prompt payment in last 12 months
number of satisfactory payment (0-30 dpd) in last 12 months
number of payment 30-60 dpd in last 12 month
number of payment 60-90 dpd in last 12 month
number of payment 90-120 dpd in last 12 month
number of payment 120+ dpd in last 12 month
   *dpd: days past due.

Through local country computers 414 and central FTP site/server 416 in FIG. 4, the above data items are pooled together.

Memory 432 converts all currencies into US dollars, and creates model predictors based on the raw data items, predicators such as % of Satisfactory Experiences (0-30 dpd) that are paid promptly (0 dpd), and % of 30+ dpd experiences that are 60+ dpd, etc.

Trade data storage device 440 stores the predictors, and those predictors will be utilized by the GBR master processing module in computer 702 for GBR score creation in the GBR master scoring module computer 750. Computers 702 and 750 allow for two sequential steps. GBR master processing module 710 puts together all macro, signal, trade, financial, and derogatory data (from FIGS. 2 thru 6). GBR master scoring module 758 applies GBR models to the information stored in master database storage device 740, thereby generating and storing GBR scores in storage device 790.

FIG. 5 retrieves GBR financial information 500 from US trade database 151 and US business database 152 from trade database group 150 and country database group 160.

Databases 150 and 160 contain, among others things, the following financial information for US (databases 151 and 152) and for other countries (databases 162 thru 164):

DATE of most recent financial statement in last 3 years

total assets in most recent financial statement

net worth in most recent financial statement

net income

cash and cash equivalent amount

Through local computer 514 and server 516 in FIG. 5, the above data items are pooled together.

Financial data selection, conversion, derived variable creation module 532 converts all currencies into US dollars, and based on the raw data items above, creates predicators such as Return on Assets (ROA), and Recency of most recent financial statement, etc.

Financial data storage device 540 stores the predictors, and those predictors will be used by GBR master processing computer 702 to create a GBR score by GBR master scoring computer 750.

FIG. 6 demonstrates how to retrieve GBR global derogatory information 600 from US trade database 151 and US business database 152 from trade database group 150 and country database group 160.

Databases 150 and 160 contain, among others, the following derogatory information for US (databases 151 and 152) and for other countries (databases 162 thru 164):

collection amount in last 7 years (years vary by markets)

amount by court actions in last 7 years (years vary by markets)

director judgment amount in the past 7 years (years vary by markets)

director failure counts in the past 7 years (years vary by markets)

number of months since the last derogatory event

Through local computer 614 and servers 616 in FIG. 6, the above data items are pooled together.

Derogatory data selection, conversion, derived variable creation module 632 converts all currencies into US dollars, and generates such flag/dummy predictors as Had Debt Collections (1/0), Had Director Failures (1/0), etc. Derogatory data storage device 640 stores the predicators, and those predictors will be called later by GBR master processing computer 702, for GBR score creation in GBR master scoring computer 750.

With above explanations regarding the steps in FIGS. 2-6 for UK company ABC, together with ABC's firmographics information from global databases 110, GBR master processing module 710 in FIG. 7 matches and/or merges such firmographics information, macro scores from storage 240, signal scores from storage 330, trade data from trade data storage device 440, global financial data from financial data storage device 540, and global derogatory data from derogatory data storage device 640 at a company level. In other words, master processing module 710 creates a master data file where each business has one and only one record. For the case of ABC, master processing module 710 assemblies into a data file, side by side, firmographics data fields (e.g., age, employees size, SIC, etc.), trade, financial, and derogatory predicator data fields as explained above, as well as its signal score and UK macro score.

Master database storage device 740 normally stores the above information into a large database in the format of a matrix, with each row corresponding to a company, and each column to a data field. In the case of ABC, storage device 740 is a one-record data file with many columns of predictor values. Using one-record summarized information per company, instead of using multiple transactional records for ABC company, will save a computer processing step and time to generate the final GBR score.

As shown in FIG. 8, starting from storage device 740, with all the necessary information ready for scoring, master scoring module 758 in FIG. 7 generates the GBR score, through the following steps in FIG. 8.

First, check if trade or financial data is available for ABC

1. If there is no trade nor financial info available for ABC, then check if firmographics or signal score is available,
If no firmographics or signal score for ABC, then apply Macro_Model, generate GBR score, and save GBR score in storage device 790.
If ABC has Firmographics or signal score, then apply firmographics_signal_module to generate a GBR score, and save GBR score in storage device 790.

2. If there is trade or financial data items for ABC, then check if its' financial data available
if no financial data is available, then apply trade_derogatory_firmographics_signal_macro_model to generate a GBR score, and save the GBR score in storage device 790.
If there is financial data, then check if trade data is available
   if trade data is not available, then apply financial_derogatory_firmographics_signal_macro_model to generate a GBR score, and save the score in storage device 790.
   If trade data is available, then apply financial_trade_derogatory_firmographics_signal_macro_model, and save the scores in storage device 790.

Assuming that after the above steps, ABC is found with trade and financial information and without any derogatory data fields populated. Among trade data fields, all trades are paid promptly, and delinquency data fields are all populated 0. Among financial data items, ABC filed its most recent financial statement as of end of last fiscal year, and business performs well in terms of return of assets.

The Financial_Trade_Derogatory_Firmographics_Signal_Macro_model is used to generate GBR score, and GBR raw score is found at 1520.

GBR final output is comprised of a predictive component and descriptive component. The Predictive component is derived from GBR raw score, which ranks the raw score into 15 segments based on predefined cutoff points, with ‘15’ as the most risky. The descriptive component indicates data depth or data availability, with ‘A’ as the strongest and ‘G’ as the weakest. GBR utilizes Data Depth measure providing visibility into predictive data available for reliable assessment of a company. Data Depth component acts as confidence coefficient providing insights into the level of predictive data used to assess the future state of the business.

| Data Depth | Description | Models |
|---|---|---|
| A | Financials with Trade | Financial and Trade |
| B | Financials Only | Financial Only |
| C | Thick Trade Only | Trade Only |
| D | Thin Trade Only | Trade Only |
| E | Full Firmographics | Macro, Firmographics |
| | and Signals | and Signal |
| F | Full Firmographics | Macro, Firmographics |
| | without Signals or | and Signal |
| | Partial Firmographics | |
| | with/without Signals | |
| G | Macroeconomic Only | Macro Only |

Based on the GBR raw score of 1520 and data availability with trade and financial information, GBR master scoring module 758 assigns a GBR final output of ‘4A’ to ABC.

A score of 4 on an account in UK means the same as in Brazil in terms of risk propensity, regardless of underlying depth of data.

Finally, the score of ‘4A’ is saved in GBR score storage device 800 in FIG. 1.

Below has detailed explanation of FIGS. 9-11.

FIG. 9 discloses how to create a country adjustment factor to adjust business failure rate information in the model sample. It is one example on how we overcome weakness in data, when we were creating GBR models.

FIGS. 10 and 11 illustrate the process of how the macro model was created.

FIG. 2 provides the process of how macro scores are produced, which has been explained above.

For FIG. 9, during our GBR model creation stage, step 905 runs thee correlation test between the time series of business failures and various macroeconomic time series variables from servers 202 and 204, as well as databases 206, 208, 210, and 212.

Step 915 first creates a rank adjustment factor using a combination of principal components based on all the macro economic variables from servers 202 and 204, as well as databases 206, 208, 210, and 212, and regression analysis to generate predicted value of business failure rates. Rank adjustment factor, which is the ratio of predicted over observed business failure rate, is generated afterwards. The reason to use this projected business failures, instead of country business failure rates observed in available data, is to remove data coverage bias. Collections of business failure information varies drastically across countries. For example, the observed failure rate for Brazil is lower/better than that for UK, because failure information is not well collected in Brazil.

Step 925 stores the projected business failure rates, as well as the rank adjustment factor to adjust observed failure rate in model sample. This adjusted business failure rate is used in creating the GBR models.

Macro scores 1060 in FIGS. 10 and 11 pertain to all countries. This step corresponds to macro score 200 in FIG. 1. GBR master processing and scoring 710 in FIG. 7 combined the macro scores, together with signals, trade, financials, derogatory information. Step 925 in FIG. 9 creates rank-adjusted dependent variables. Results in step 925 are used, together with other macro information, such as GDP growth etc., to generate macro score in step 1060. If a country is macro data thin in step 1025 of FIG. 10, mostly among developing countries, usually their trade, financial, derogatory, and signal data are also less abundant, because of less advanced information structure for data collections. Because of less information available, it adversely impacts the accuracy of the final GBR score because predictors for those countries have many missing values.

Model in 1055 uses the required variables and produces UK country macro score (e.g., UK macro score=1539, a low risk score). This UK macro score, as explained above regarding signal score with detailed mathematical formula and calculations, follows the same method, except macro score uses different formula and calculations from signal score. Normally 1000-1200 are high risk scores, and 1500+ are low risk scores.

Databases 350 through 356 in FIG. 3 pool all available signal data item and processing module 318 (i.e. a regression equation) generates signal score for ABC (e.g., ABC signal score=1435, a mid-level risk score).

FIG. 1 indicates thick trade data are available in UK local database 162. In local database 162, if a company has 3+ trade information, we consider it having thick trade. Thick trade is good for score accuracy, because thick data is available, while neither derogatory (an indication of lower risk) nor financials is available. GBR global trade information 400 in FIG. 1 extracts trade information for ABC company from UK local database 162.

GBR master processing module 710 in FIG. 7 pools together ABC's firmographics, macro score, signal score, and trade information. Master database storage device 740 saves the results

GBR master scoring module 758 in FIG. 7 produces the GBR score for ABC, e.g., pursuant to the logic flow diagram set forth in FIG. 8.

Starting with “Start 758”, the system determines if either trade or financial information 801 is available. If either is available, then the system checks to see if financials are available 803. If no financials are available, then the system moves to “SCORECARD: Trade/Derogatory/Firmographics/Signal/Macro Model” 805 and uses all the available data in 740, and creates a GBR score for ABC (GBR=“4C”), where “4” denotes low risk, and “C” indicates good in data availability and in score confidence. The score of “4C” is saved in GBR score storage device 800.

If financial information is available, then the system checks to determine if trade information is available 807. If no trade information is available, then the system moves to “SCORECARD:

Financials/Derogatory/Firmographics/Signal/Macro Model” 809 and uses all the available data in 740, and creates a GBR score for ABC (GBR=“4C”), where “4” denotes low risk, and “C” indicates good in data availability and in score confidence. The score of “4C” is saved in GBR score storage device 800.

If both financial and trade information is available, then the system moves to “SCORECARD: Financials/Trade/Derogatory/Firmographics/Signal/Macro Model” 811 and uses all the available data in 740, and creates a GBR score for ABC (GBR=“4C”), where “4” denotes low risk, and “C” indicates good in data availability and in score confidence. The score of “4C” is saved in GBR score storage device 800.

If neither financial or trade information is available 801, then the system checks to determine if firmographic or signal data is available 813. If yes, then the system moves to “Scorecard: Firmogrphics/Signal/Model” 815 and uses all the available data in 740, and creates a GBR score for ABC (GBR=“4C”), where “4” denotes low risk, and “C” indicates good in data availability and in score confidence. The score of “4C” is saved in GBR score storage device 800.

If neither firmographic or signal data are available, then the system moves to “Scorecard: Macro” 817 and uses all the available data in 740, and creates a GBR score for ABC (GBR=“4C”), where “4” denotes low risk, and “C” indicates good in data availability and in score confidence. The score of “4C” is saved in GBR score storage device 800.

The present disclosure having been thus described with particular reference to the preferred forms thereof, it will be obvious that various changes and modifications may be made therein without departing from the spirit and scope of the present disclosure as defined in the appended claims.

What is claimed is:

1. A networking system for real-time generation of a global business ranking based upon country specific data retrieved from at least a plurality of countries, said system comprising:
a plurality of country data collection systems, wherein said country specific data is collected from a plurality of country sources;
a transformation engine which receives and categorizes said collected data into at least one selected from the group consisting of: country trade data, country financial data and country derogatory information;
a data/attribute repository which merges said country trade data, country financial data and/or country derogatory information with data from a global database, macro score data and/or signal score data to form merged data, and sorts said merged data into at least one selected from the group consisting of: global trade data, global financials data and global derogatory information; and
a global business ranking processor which retrieves any of said global trade data, global financials data and/or global derogatory information on a real-time basis and generates said global business ranking for a particular business entity.

2. The system according to claim 1, wherein said global business ranking processor comprises a blended module which produces said global business ranking even if any or all of said global trade data, global financials data and/or global derogatory information is incomplete by using a statistical model or business knowledge to fill in any deficient information or data.

3. The system according to claim 2, wherein said global business ranking is stored in global business ranking repository.

4. The system according to claim 1, wherein said a transformation engine further processes said collected data by translating, standardizing and/or summarizing said collected data pursuant to country specific logic and/or rules.

5. The system according to claim 1, wherein said country data collection system comprises parallel processing of said country specific data from said plurality of country sources.

6. The system according to claim 5, wherein said global business ranking repository pushes global business rankings for said business entity downstream and/or continuously feeds said global business rankings for said business entity to a user in real-time without the need for awaiting the downloading and/or processing of all said country specific data.

7. The system according to claim 6, wherein said global business ranking which have been provided to said user is fed back to said global business ranking processor via neural net or other artificial intelligence technology to improve said global business ranking generated via said global business ranking processor.
